(19) United States
(12) Patent Application Publication
(10) Pub. No.: US 2009/0223392 A1
(43) Pub. Date: Sep. 10, 2009

(54) Device and method for printing objects

(76) Inventor: Mircea Iliescu, Ellwangen (DE)

Correspondence Address: Raymond R. Ferrera, 1221 McKinney Street, Suite 4400, Houston, TX, 77010, US

(21) Appl. No.: 12/390,773

(22) Filed: Feb. 23, 2009

(30) Foreign Application Priority Data
Feb. 26, 2008 (DE) 10 2008 000 416.2

(51) Int. Cl. B41F 31/00; B41L 3/02

(52) U.S. Cl. 101/141; 101/486

(57) ABSTRACT

The invention relates to a device and a method to print objects employing a letterpress or offset printing method. The surface of the object to be printed or the holding device respectively is measured before printing so as to determine deviations of the distance and the parallelism between the impression cylinder and the object accommodated in a holding device. Based on this measuring, the inclination of the impression cylinder and its distance is adjusted by the holding device either before or during printing.

### STATEMENT OF RELATED CASES

Pursuant to 35 U.S.C. 119(a), the instant application claims priority to prior German application number 10 2008 000 416.2, filed Feb. 26, 2008.

The invention relates to a device and a method for printing objects, especially cylindrical objects, especially by means of a letterpress printing method such as the flexographic printing method.

So far, the screen printing method is often employed for the printing of objects such as glasses, bottles (made of plastic or glass) or tubes and, among others, also foils and paper. This printing method has the advantage that the printing quality is relatively independent of slight variations of the distance between the screen printing fabric and the object to be printed, as the ink is pressed through the flexible screen printing fabric onto the object to be printed by means of a blade.

The screen printing method, however, also has disadvantages when compared to other known printing methods. By means of the letterpress printing method, such as the flexographic printing method, for instance, finer structures can be printed, which is of advantage especially when images with a high resolution—even multicoloured as the case may be—are to be printed. The printing quality of letterpress and offset printing methods, however, is decisively depending on a correct alignment of the impression cylinder with the object to be printed. The distance between impression cylinder and object has to be kept as uniform as possible over the complete area to be printed. Deviations of only 0.01-0.02 mm result in a severely reduced quality of the printing image.

As concerns sheet-fed and web printing, this does not cause a problem, as the sheet or web to be printed is passed over a backpressure cylinder, which is provided with supports at both ends.

During the printing of objects, especially of cylindrical objects, the object is often completely or partially closed at one end, for instance glasses, bottles made of plastic or glass or tubes for cosmetic products, which are printed before filling and closing and are therefore basically cylindrical.

Before printing, the objects to be printed are accommodated in a holding device and will be accommodated in it during the printing process. Cylindrical objects, for instance, can be pushed onto a holding mandrel and held by the holding mandrel, for instance, by a radial expansion of the holding mandrel. Such holding or expanding mandrel is described in the German utility model DE 20 2004 019 382 U1.

In another possible holding device, the object to be printed is held within the holding device by the generation of negative pressure. Often, mechanical clamping devices are employed, which are pushed onto the cylindrical object, thus holding the object during the printing process.

The holding device is supported at one end. A support at the opposing end is not possible as the object accommodated is often (partially) closed at that end. It is neither possible to support the holding device by a backpressure cylinder, as the holding device rotates around its own axis during the printing process and, thus, the surface of the object accommodated in the holding device already printed would be in contact with the backpressure cylinder. As a result, the printing ink would get onto the backpressure cylinder smudging the object to be printed.

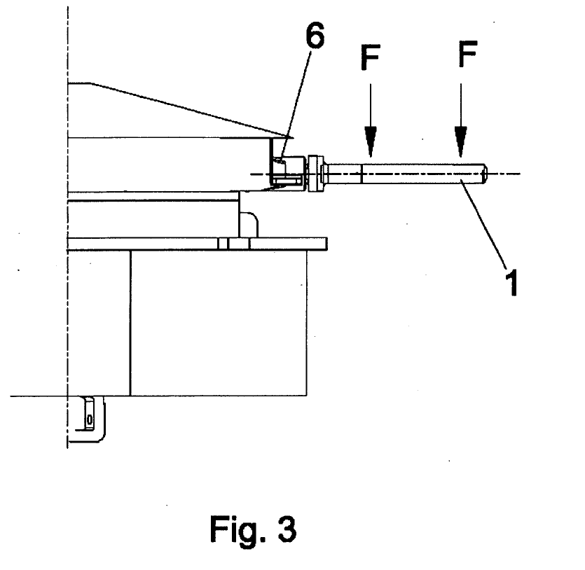

During the printing process, however, a force is exerted onto the holding device via the impression cylinder. Due to unavoidable tolerances in the production of the holding device and its supports, the holding device will slightly swerve in the direction of the force exerted by the impression cylinder. This swerving movement is, as shown in FIG. 3 for a holding mandrel, larger at the non-supported end of the holding mandrel than on the supported end, so that the inclination of the holding mandrel with reference to the impression cylinder changes. In addition, the temperature of the printing device varies during operation causing length changes resulting in a deviation of the position of the components of the holding and/or printing device compared to the initial position.

After all, holding devices can be modified to match the particular print job. In this respect, due to unavoidable production tolerances, it often cannot be ensured that the position of the components of the holding device after the modification exactly correlates with the position before the modification.

For these reasons, the relative position of the holding device and impression cylinder changes, whereupon the printing of the object accommodated in the holding device will not be optimal any more.

Further reasons for a deterioration of the printing quality can be a varying wall thickness of the objects to be printed, whereupon the distance from the impression cylinder to the surface of the object varies either during the printing of an object or between the processes of printing various objects.

When using a rotary-cycle plant for printing, where, for instance, different inks are applied at the individual work stations, production-related tolerances can result in a non-exact alignment among the print units of the rotary-cycle plant and the transport device for the holding devices. As a result, the distance from the impression cylinder to the surface of the object to be printed can vary between the individual work stations also resulting in a deterioration of the printing quality.

It is therefore an object of the invention to provide a device for the printing of cylindrical objects, which allows a high-quality printing of the objects also with a letterpress printing unit, even when the distance between object and impression cylinder varies. This object is solved by a device for the printing of objects according to the present invention.

A device for the printing of objects according to the present invention comprises a printing unit with a printing mechanism mounted on a carrier unit. The printing mechanism comprises at least one anilox roller to receive the ink and one impression cylinder onto which the ink is at least partially transferred by the anilox roller. The printing mechanism may comprise further intermediate rollers to transfer the ink.

Depending on the printing method for which the device subject matter to this invention is to be used, a printing plate or a printing sleeve can be mounted on the impression cylinder, for instance an offset printing plate (e.g. for offset printing) or a letterpress printing plate (e.g. for flexographic printing).

A device subject matter of this invention further comprises a holding device, which can accommodate an object to be printed such as a glass, a bottle or a tube. Preferably, the holding device is a holding mandrel with an outer diameter only slightly smaller than the inside diameter of the object to be printed. An object to be printed can then be easily pushed onto the holding mandrel.

A possible embodiment of the holding device provides that compressed air can be applied onto the holding mandrel, whereupon flexible elements inside the holding mandrel expand and metal fins forming the surface of the holding mandrel move outwards. Through this, the object to be printed is securely accommodated in the holding mandrel and can be rotated along its longitudinal axis by rotating the holding mandrel, so that the object can be printed circumferentially by the printing plate mounted on the impression cylinder.

In another possible embodiment, the object to be printed is held within the holding device by the generation of negative pressure. Another embodiment provides a mechanical clamping device.

If the object to be printed is not cylindrical inside, the holding device can also be matched to the inside form of the object to be printed.

A device subject matter of this invention further comprises a measuring device with which the surface of an object accommodated in the holding device can be measured. A further possibility is the measuring of the surface of the holding device. Preferably, the measuring device is attached in a known alignment to the basic body of the device subject matter of this invention and is able to measure the surface of an object accommodated in the holding device or the surface of the holding device respectively at one or more points either with the holding device fixed or during the rotation of the holding device around its own axis. Measurement of the surface of the object or the holding device respectively means that the position of points on the surface is determined relative to a known point, for instance from a basic body of the device.

Through this it is possible to take a measurement of the circumferential profile of the object to be printed or the holding device respectively at one are several points along its length.

It is however not always required to measure the surface completely. To measure, for instance, the inclination of the holding device, it is sufficient to determine the distance from the surface of an object accommodated in the holding device or the holding device respectively to the measuring device at two points.

By such measurement, the alignment of an object accommodated in a holding device or the holding device respectively can be determined, for instance the inclination of the holding device. In addition, it can be determined whether during the rotation of the holding device around an axis the distance from the surface of an object accommodated in the holding device to the measuring device is constant or varies, i.e. whether the material thickness of the object is uniform.

It can also be determined whether the material thickness of all objects to be printed is identical or whether different objects have different material thicknesses.

A device subject matter of this invention further comprises a control device with which the inclination of the printing mechanism with reference to the holding device and/or the distance of the printing mechanism and especially of the impression cylinder can be adjusted by the holding device. Preferably, the inclination and/or the distance of the printing mechanism is adjusted in such a way that an optimal printing quality is obtained on the object previously measured with the measuring device.

In a preferred embodiment of the device subject matter of this invention, the control device comprises at least one actuating element to adjust the inclination of the printing mechanism with reference to the holding device and/or the distance of the printing mechanism of the holding device. In a particularly preferred embodiment, the actuating element is an actuating cylinder attached to a first end of the carrier unit and with the other end to the basic body of the device subject matter of this invention.

Through this, it is possible to change the alignment of the carrier unit and thus the printing unit fixed to the carrier unit with reference to the basic body. Preferably, the control device comprises two actuating cylinders attached to one end to the carrier unit and with the other end to the basic body of the device subject matter of this invention. In such arrangement, the first actuating cylinder is preferably arranged above the first front face of the impression cylinder and the second actuating cylinder is preferably arranged above the second front face of the impression cylinder. The actuating cylinders may also be arranged below the impression cylinder. The actuating cylinders are preferably driven by a linear or servo motor.

In a further especially preferred embodiment of the device subject matter of this invention, the actuating cylinder is attached pivotably at its first end around an axis vertical to the actuating direction to the carrier unit and is attached pivotably at its second end around an axis vertical to the actuating direction to the basic body.

Consequently, the inclination of the printing mechanism with reference to the holding device and/or the distance of the printing mechanism and especially the impression cylinder of the holding device can be so adjusted that an optimal printing quality is reached on the object.

For a device subject matter of this invention, the control device of which only comprises a single actuating element (e.g. only one actuating cylinder), an adjustment of the distance of the printing mechanism and especially the impression cylinder by the holding device is impossible. However, the inclination of the printing mechanism with reference to the holding device can be adjusted. Preferably, the individual actuating cylinder is arranged above one of the two front faces of the impression cylinder, whereas the carrier unit is attached pivotably above the other of the two front faces of the impression cylinder to the basic body.

According to the invention, even a single actuating element can be used, which allows the adjustment of both the inclination of the printing mechanism with reference to the holding device and the distance of the printing mechanism and especially the impression cylinder of the holding device.

In a further especially preferred embodiment of the device subject matter of this invention, the measuring device comprises at least one tracer device for the mechanical tracing of the surface of the cylindrical object accommodated in the holding mandrel or the surface of the holding device respectively.

Such a tracer device consists, for instance, of a tracer, which is slidable and partially guided inside a housing. The housing of the tracer device is connected to the basic body of the device subject matter of this invention and the tracer contacts the surface to be measured during measuring. Preferably, the alignment of the tracer is substantially vertical to the surface of the object at the point the tracer contacts the holding mandrel or the object. By changing the inclination of the holding device or the wall thickness of the object to be printed, the tracer is shifted with reference to the housing of the tracer device. Such shifting can be measured producing information about the arrangement of the surface. Such a tracer is, for instance, offered by Heidenhain under the designation “ST 3077”.

But the measuring device can also operate with optical or acoustical methods so as to measure the individual surface.

In a further especially preferred embodiment of the device subject matter of this invention, the device is a rotary-cycle machine with several work stations, between which an object to be printed can be transported with a holding device. In such an arrangement, the measuring device is installed on a first work station and the printing unit, with which the object is printed, and the control device are installed on a second work station. Preferably, in this case, the first work station is also provided with a printing unit, with which the printing method can be simulated so as to determine the alteration of the inclination of the holding device when the impression cylinder pushes against the object accommodated in the holding device.

Usually, rotary-cycle machines are used for the printing of cylindrical objects when more than one production step is required. Production steps can be, for instance, the printing with one each ink to produce a multicolour print on the object. Another possible production step is, for instance, the pre-treatment of the surface of the object to be printed so as to improve the adhesion of the inks on, the surface. Such a method is known under the name UVitro and is described in the European patent EP 1 148 036 B1. Another possible production step is the treatment of the object before or after printing with a varnish.

According to the invention, the measurement of the surface of an object to be printed accommodated in a holding device is intended as a production step on a rotary-cycle machine.

This is especially advantageous when the measurement of the surface of the object to be printed or the holding device respectively is to be taken not only at one point or several points with the holding device fixed, but when the surface of the object to be printed or the holding device is to be taken during a complete rotation of the holding device. As the measurement of the surface cannot be taken at the point where it is being printed, the measuring device has to be arranged staggered to the printing unit. The measuring device, for instance, can be arranged opposite the printing unit on the holding device.

This then causes the holding device to make half a rotation before the measured part of the surface of the object to be printed reaches the printing unit where it can be printed. To produce a circumferential print on a cylindrical object, it is thus necessary that the holding device rotates one and a half rotations, whereupon the production rate of the rotary-cycle machine is significantly reduced.

It is therefore advantageous to arrange the measuring device on an otherwise free work station of the rotary-cycle machine, so that an object to be printed or the holding device respectively at this work station can be measured during a full rotation of the holding device, while a previous object is being printed at the work station with the first printing unit. Through this, the printing of an object with only one complete rotation of the holding device is made possible and half a rotation is saved.

When it is known that the objects to be printed have a sufficiently uniform wall thickness and only the production-related tolerances of the accommodating mandrel are to be compensated, it is sufficient to measure all accommodating mandrels only once before starting the printing process and then to adjust the individual printing mechanisms at the particular holding mandrel.

In a preferred embodiment of the device subject matter of this invention, the device comprises a storage device to store the data of the surface of the holding mandrel or the cylindrical object accommodated in the holding mandrel measured by the measuring device.

The data of the surface can be stored, for instance at a first work station of a rotary-cycle machine. When printing the object at further work stations of the rotary-cycle machine the stored data can be retrieved.

A device subject matter of this invention for the printing of cylindrical objects can be used for all printing methods where a printing plate or a similar component is mounted on an impression cylinder.

In an especially preferred embodiment of the device subject matter of this invention, the printing mechanism is a flexographic printing mechanism.

The present invention relates to a method for the printing of objects with a device as described above. This device comprises a printing unit with a printing mechanism mounted on a carrier unit comprising an anilox roller and an impression cylinder and a holding device to accommodate the object to be printed.

In one step of the method subject matter of the invention, the surface of the cylindrical object accommodated in the holding device or the holding device respectively is measured. The measurement of the holding mandrel or the object can be taken at one or several points either with the holding device fixed or during the rotation of the holding device around an axis.

It is not necessary to measure the surface completely. To determine, for instance, the inclination of the holding device, it is sufficient to determine the distance from the surface at two points.

By such measuring, the alignment of an object accommodated in the holding device or the holding device respectively can be determined, i.e., for instance, the inclination of the holding device. In addition, it can be determined whether during the rotation of the holding device around an axis the distance from the surface of an object accommodated in the holding device is either constant or varies, i.e. whether the material thickness of the object is uniform.

It can also be determined, whether the material thickness of all objects to be printed is identical or whether different objects have different material thicknesses.

In a further step of the method subject matter of the invention, the inclination of the printing mechanism with reference to the holding device and/or the distance of the printing mechanism is adjusted by the holding device. For this, the data obtained when measuring the surface of the object are used. Thus, it is possible to adjust the inclination and/or distance of the printing mechanism optimally to the object to be printed.

In a further step of the method subject matter of the invention, the object accommodated in the holding device is printed by the printing mechanism. Due to the optimal alignment of the printing mechanism with reference to the holding device and, thus, the object to be printed, an optimal printing quality can be reached.

In a preferred embodiment of the method subject matter of this invention, each of the mentioned steps is fully completed before the next step is started. This means that at first the surface of the object to be printed or the holding device respectively is measured as required. For instance, the inclination of the holding device can be determined by the determination of the distance of the surface of the object by a measuring device, while the impression cylinder applies a force onto the object accommodated in the holding device.

Only then the inclination of the printing mechanism with reference to the holding device and/or the distance of the printing mechanism is adjusted by the holding device. This adjustment is then maintained, whereas the object is printed by the printing mechanism. A variation of the wall thickness of the cylindrical object to be printed cannot be compensated during this serial performance of the process steps, however, it is possible to compensate the tolerances in the components such as the holding device supports.

For this embodiment of the method, the step of measuring the surface is preferably performed at a first work station of a rotary-cycle machine and the two steps of adjusting the inclination and/or distance of the printing mechanism and the printing of the object are preferably performed at a second work station of the rotary-cycle machine. Through this, it is possible to perform the step of measuring the surface of a first object simultaneously with the steps of adjusting the inclination and/or the distance of the printing mechanism and the printing of a second object.

In a further preferred embodiment of the method subject matter of this invention, the steps of adjusting the inclination and/or distance of the printing mechanism and the printing of the cylindrical object are performed simultaneously, i.e. the inclination of the printing mechanism with reference to the holding mandrel and/or the distance of the printing mechanism from the holding mandrel are adjusted continuously during the rotation of the holding mandrel. This ensures, in addition to the compensation of tolerances in the components, the compensation of variations of the wall thicknesses of the cylindrical object to be printed.

In a further preferred embodiment of the method subject matter of this invention, the step of measuring the surface is carried out at least partially simultaneously with the step of adjusting the inclination of the printing mechanism with reference to the holding device and/or the distance of the printing mechanism by the holding device and/or with the step of printing the object accommodated in the holding device.

For this, the measuring device and the impression cylinder of the printing mechanism are arranged staggered around the holding device. Preferably, the measuring device and the impression cylinder of the printing mechanism are arranged opposite each other. It is then possible to measure the surface and to use the data obtained to adjust the inclination and/or distance of the printing mechanism when the holding device has performed half a rotation.

In a further preferred embodiment of the method subject matter of this invention, the measuring of the surface of the object to be printed or the surface of the holding device is performed with a tracer device. Such a tracer device consists, for instance, of a tracer which is slidable and partially guided in a housing. The housing of the tracer device is connected with the basic body of the device subject matter of the invention and the tracer contacts the surface during measuring. In this case, the preferred alignment of the tracer is substantially vertical to the surface at the point where the tracer contacts the object or the holding device respectively. By changing the inclination of the holding device or the wall thickness of the object to be printed the tracer is shifted with reference to the tracer device housing. This shifting can be measured and information about the arrangement of the surfaces of the object to be printed accommodated in the holding device or the holding device respectively can be obtained.

In a further preferred embodiment of the method subject matter of this invention, the data obtained when measuring the surface are stored in a storage device. In an especially preferred embodiment, the adjustment of the inclination of the printing mechanism with reference to the holding device and/or the distance of the printing mechanism by the holding device is then made based on the data stored in the storage device. It is thus also possible to adjust several printing mechanisms (e.g. for several inks) of different work stations of a rotary-cycle machine to the object to be printed, each of them in an optimal way.

The storage of the data of the surface can be performed, for instance, at a first work station of a rotary-cycle machine. When printing the object at further work stations of the rotary-cycle machine the stored data can be retrieved.

The method subject matter of the invention to print cylindrical objects can be employed for any printing method where a printing plate or a similar component is mounted on an impression cylinder.

In a further preferred embodiment of the method subject matter of this invention, the printing of the cylindrical object accommodated in the holding mandrel is performed by a flexographic printing mechanism employing the flexographic printing method.

The device subject matter of the invention and the process subject matter of the invention are suitable for the printing of substantially cylindrical objects and objects the outer form of which deviates from a cylinder. For objects the outer form of which deviates from a cylinder, the deviation is compensated during the rotation of the holding device by the at least one actuating element subject matter of the invention. The device subject matter of the invention, for instance, allows the printing of objects the cross-section of which vertical to a longitudinal axis is either oval or egg-shaped. Flat objects such as foils or paper, however, can also be printed.

In the following, the invention is explained in detail by means of the drawing. The drawing shows:

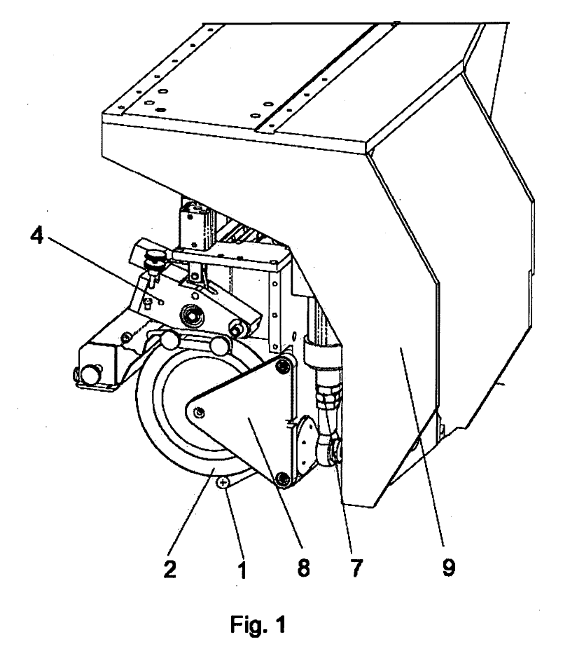

FIG. 1 a spatial representation of a device subject matter of the invention for the printing of cylindrical objects in a rotary-cycle plant;

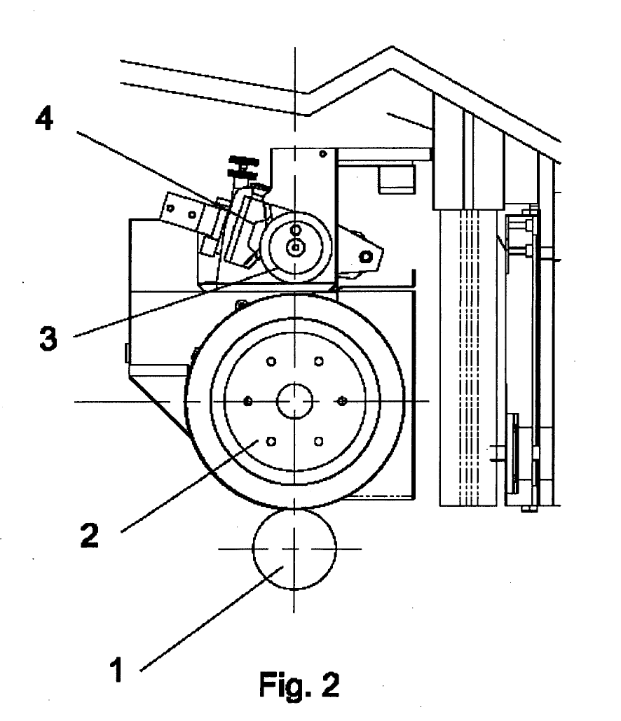

FIG. 2 a schematic representation of the flexographic unit of the device of FIG. 1;

FIG. 3 a side view of a holding mandrel (holding device) of the device of FIG. 1;

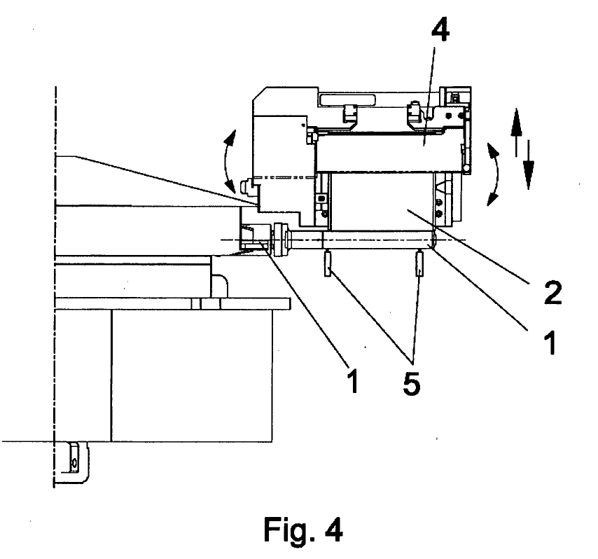

FIG. 4 a schematic side view of the flexographic printing unit of FIG. 2; and

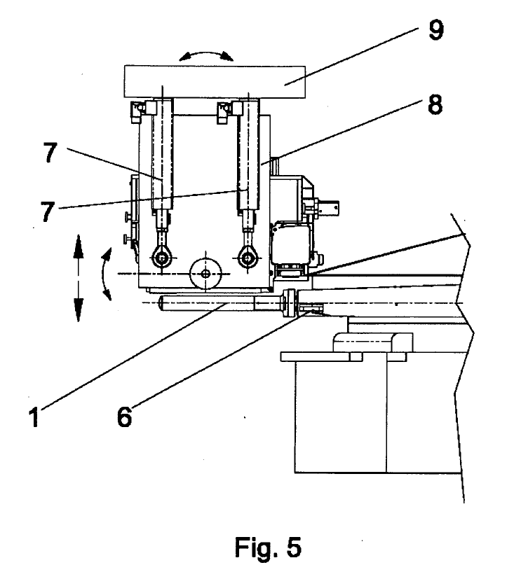

FIG. 5 a preferred embodiment of a flexographic printing unit with a control device to adjust the distance and/or inclination of the printing mechanism.

FIG. 1 shows a device subject matter of the invention for the printing of objects, which can be attached to a work station of a rotary-cycle plant. A simplified, schematic representation of the printing mechanism and the holding mandrel of the device are shown in FIG. 2.

An image-producing impression cylinder (2) onto which a flexographic printing plate is attached, which transfers the printing ink from the anilox roller (3) onto the printing medium, acts on a holding mandrel (1), which accommodates and fixes the printing medium (i.e. the cylindrical object to be printed). The regulation of the ink supply of the anilox roller (3) is done by a chamber-type blade system (4). In this system, the surplus printing ink is scraped from the anilox roller by a doctor blade. The quantity of the printing ink volume to be transferred is controlled by the selection of anilox rollers with different rulings, that is engravings on the surface of the anilox roller (3) with different densities and depths.

FIG. 3 shows a side view of the holding mandrel (1) onto which a force F is applied, for instance, produced by an impression cylinder not shown in this figure. The single support (6) at one end of the holding mandrel (1), which, due to the printing medium, is unavoidable in many cases as the body to be printed is already (partially) closed at one side of the cylinder, is the reason for tolerances with respect to unirotation and position stability. These cause the holding mandrel (1) to deflect downwards at the end not supported as a result of force F acting on it.

FIG. 4 shows a side view of the flexographic printing unit and the degrees of freedom of the roller arrangement to be regulated.

The vertical distance between the anilox roller (3) and the impression cylinder (2) refers to the complete length of the anilox roller (3). This degree of freedom is independent of probable tolerances of the holding mandrel (1) or variations of the wall thickness of the printing medium. It is thus sufficient to adjust this degree of freedom only once after mounting the printing plate on the impression cylinder (2).

The distance between the impression roller (2) and the holding mandrel (3) is a degree of freedom that can be adjusted with a device subject matter of an invention. A regulation regarding this degree of freedom refers to both the impression cylinder (2) and the anilox roller (3) as they are mounted on the same carrier unit.

Another degree of freedom, which can be adjusted with a device subject matter of an invention is the parallelism of the impression cylinder (2) and the holding mandrel (1). A dislocation within this degree of freedom refers to both the impression cylinder (2) and the anilox roller (3) as they are mounted on the same carrier unit. By a change of the inclination of this carrier unit, the parallelism between the impression cylinder (2) and the holding mandrel (1) can be adjusted.

A still further degree of freedom is the longitudinal position of the printed image on the printing medium, which is located on the holding mandrel (1). This degree of freedom refers to both the impression cylinder (2) and the anilox roller (3) as they are mounted on the same carrier unit. This degree of freedom is also independent of probable tolerances of the holding mandrel (1) or variations of the wall thickness of the printing medium. It is thus sufficient to adjust this degree of freedom only once after mounting the printing plate on the impression cylinder (2).

Remaining are the degrees of freedom of the distance indicated by the arrows in FIG. 4 between the impression cylinder (2) and the holding mandrel (1) (or the object held on the holding mandrel (1)), which have to be either adjusted before printing of a printing medium on the holding mandrel (1) or have to follow up during printing.

Two sensors (5) with which the distance between the surface of a printing medium accommodated on the holding mandrel (1) or the surface of the holding mandrel and the sensor can be measured are also schematically shown in FIG. 4. From these two distances, the inclination of the holding mandrel (1) can be determined when a force is exerted on them by the impression cylinder (2). The two sensors are tracer devices consisting of a tracer, which is slidable and partially guided in a housing. The housing of the tracer device is connected with the basic body (not shown) of the printing device and the tracer contacts the surface during measuring. Changes of the distance between the surface and the sensor housings therefore cause the tracer to shift relative to the housing and can thus be measured.

FIG. 5 shows a preferred embodiment of a flexographic printing unit with a control device to adjust the inclination of the printing mechanism (2, 3, 4) with reference to the holding mandrel (1) and/or the distance between the printing mechanism (2, 3, 4) and the holding mandrel (1). The printing mechanism is mounted on a carrier unit (8).

By changing the length of the two actuating pistons (7) one end of which is attached to the carrier unit (8) and the other end of which is attached to a basic body (9), the inclination and/or distance of the printing mechanism (2, 3, 4) can be adjusted.

The deviation of the parallelism between the holding mandrel (1) and the impression cylinder (2) determined by the sensors (5) can be compensated via the two actuating pistons (7). This is done by the two actuating pistons (7) correcting the actuating angle between the impression cylinder (2) and the holding mandrel (1). For instance, the length of one of the two actuating pistons (7) can be changed, whereas the length of the other one remains unchanged, or one actuating piston can be extended and, simultaneously, the other one shortened.

To compensate the production-related tolerances of the wall thickness of the cylinder to be printed, which is located on the holding mandrel (1), the position of the carrier unit (8) with the printing mechanism mounted on it can be vertically changed by a parallel length change of the impression cylinder (2) by the actuating pistons (7). The length of the two actuating pistons (7) can, for instance, either be extended or reduced by the same amount.

Both adjusting possibilities can be controlled simultaneously, by, for instance, the extension of both actuating pistons (7), however, one extending farther than the other. This then results in a changing of the inclination angle of the printing unit and a simultaneous reduction of the distance between the impression cylinder (2) and the holding mandrel (1).

This ensures that the impression cylinder (2) and the printing medium located on the holding mandrel (1) contact each other in a way optimal for the printing process and that the process is monitored and regulated.

### REFERENCE LIST

1 Holding mandrel (holding device)
2 Plate cylinder
3 Anilox roller
4 Chamber-type blade system
5 Sensors
6 Support of the holding mandrel
7 Actuating piston
8 Carrier unit
9 Basic body

1. Device for generating shock waves, comprising a first conductive tip and a second conductive tip, which are arranged in a liquid bath, wherein a first voltage source and a second voltage source are provided for applying a voltage (U1, U2), respectively, between the first tip and the second tip, wherein the first voltage source and the second voltage source are operated such that the respective voltages (U1, U2) between the tips are added up.

2. Device for generating shock waves according to claim 1, wherein the device for generating shock waves comprises a capacity which is connected in parallel with the tips.

3. Device for generating shock waves according to claim 1, wherein both the first voltage source and the second voltage source generate a voltage (U1, U2), respectively, which is lower than a breakdown voltage (Ud) between the first tip and the second tip in the liquid bath, wherein at least one of the voltage sources is regulable or controllable.

4. Device for generating shock waves according to claim 1, wherein the voltage (U1) of the first voltage source is in the range of 5 kV to 20 kV and/or the voltage (U2) of the second voltage source is in the range of 1 kV to 10 kV and/or the breakdown voltage (Ud) between the tips is 21 kV to 30 kV.

5. Device for generating shock waves according to claim 1, wherein the second voltage source comprises a transformer.

6. Device for generating shock waves according to claim 1, wherein a device is provided for settling a distance (d) of the tips in the liquid bath.

7. Device for generating shock waves according to claim 1, wherein the liquid bath has a conductivity of 20 μS/cm to 300 μS/cm and/or the distance (d) of the tips is between 0.5 mm and 3 mm.

8. Device for generating shock waves according to claim 1, wherein the tips completely or partly consist of metal.

9. Device for generating shock waves according to claim 1, wherein the first voltage source and the second voltage source are arranged in a base station and the tips are arranged with the liquid bath in an hand unit, wherein the hand unit and the base station are connected to each other by means of a high voltage suitable cable.

10. Method for generating shock waves, comprising the following steps:
applying a first voltage (U1) between a first conductive tip and a second conductive tip wherein the tips are arranged in a liquid bathe;
applying a second voltage (U2) between the tips in such a way, that the first voltage (U1) and the second voltage (U2) add up to a voltage which is greater than a breakthrough voltage (Ud) between the tips.

11. Method according to claim 10, wherein a tip distance (d) between the first tip and the second tip is settled before applying the first voltage (U1) or the second voltage (U2).

12. Method according to claim 10, wherein the settled distance of the tips (d) is between 0.5 mm and 3 mm at a conductivity of the liquid in the liquid bath of 20 μS/cm to 300 μS/cm.

13. Method according to claim 10, wherein the first applied voltage (U1) is in the range of 5 kV to 20 kV and/or the second applied voltage (U2) is in the range of 1 kV to 10 kV and/or the breakdown voltage (Ud) between the tips is 21 kV to 30 kV.

14. Method according to claim 10, characterized by using water as a liquid bath.

15. Method according to claim 10, characterized by providing the first voltage (U1) at the tips by means of a capacity connected in parallel with the tips.

16. Method according to claim 10, characterized by providing the second voltage at the tips by means of a high voltage source with a transformer.
